(19) United States
(12) Patent Application Publication
(10) Pub. No.: US 2019/0039141 A1
(43) Pub. Date: Feb. 7, 2019

(54) PRE-SINTERED PREFORM AND PROCESS

(71) Applicant: GENERAL ELECTRIC COMPANY, Schenectady, NY (US)

(72) Inventors: Yan CUI, Greer, SC (US); Srikanth Chandrudu KOTTILINGAM, Greenville, SC (US); Brian Lee TOLLISON, Honea Path, SC (US); Matthew LAYLOCK, Mauldin, SC (US); Timothy PLETCHER, Greenwood, SC (US)

(21) Appl. No.: 15/670,463

(22) Filed: Aug. 7, 2017

(51) Int. Cl. B22F 3/16; C22C 19/07; C22C 30/00; B22F 1/00; B23K 1/00; F01D 25/00

(52) U.S. Cl. CPC B22F 3/162; C22C 19/07; C22C 30/00; B22F 1/0003; F05D 2230/22; F01D 25/005; B22F 2301/15; B22F 2201/20; B23K 1/00

(57) ABSTRACT

A process includes placing a powder composition of a first metal powder of a first alloy and a second metal powder of a second alloy in a ceramic die and sintering the powder composition in the ceramic die to form a sintered rod in the ceramic die. The process also includes removing the sintered rod from the ceramic die and slicing the sintered rod into a plurality of pre-sintered preforms.

### FIELD OF THE INVENTION

The present embodiments are directed to pre-sintered preforms and processes of forming and using pre-sintered preforms. More specifically, the present embodiments are directed to chiclet-shaped pre-sintered preforms formed from a sintered rod.

### BACKGROUND OF THE INVENTION

Some turbine hot gas path components may include one or more sheets of material applied over a portion or portions of the underlying component. For example, during pre-sintered preform (PSP) fabrication, one or more sheets of material are brazed onto a turbine component, such as a shrouded blade, a nozzle, or a bucket. The PSP sheets are usually overlaid then brazed onto the component to form an external surface or skin. Typically, the sheets are substantially flat or include a curvature that is generally similar to the overall geometry of the component surface to which they become attached, although, through pressure, bending, and the like, these flat sheets may be conformed to the underlying component surface during the attachment process.

Certain gas turbine components have shrouds at the outer extremity of the airfoil. The blade shrouds are typically designed with an interlocking feature, usually in the form of a z-notch, which allows each component to be interlocked at its shroud with an adjacent neighbor component when such components are installed about the circumference of a turbine disk. This interlocking feature assists in preventing the airfoils from vibrating, thereby reducing the stresses imparted on the components during operation.

Turbine hot gas path components are typically made of nickel-based superalloys or other high temperature superalloys designed to retain high strength at high temperature, and the shroud material of the turbine component and the interlocking z-notch may not be of a sufficient hardness to withstand the wear stresses and rubbing that occur during start-up and shut down of a turbine engine. To improve the wear at these locations, a hardface chiclet PSP may be brazed or welded to the z-notch to serve as a wear surface. The hardface material bonded to the respective z-notches protects each notch within each shroud from wear arising from frictional contact during operation, when the turbine components are under centrifugal, pressure, thermal, and vibratory loading.

T800, a cobalt-chromium-molybdenum alloy, is largely used in gas turbine buckets to inhibit wear at the z-notch hardfacing location. The microstructure of T800 includes about 50% of a hard intermetallic laves phase (molybdenum silicides) dispersed in a softer cobalt alloy matrix. This provides a material with exceptional metal-to-metal wear properties. The laves phase has a melting point of about 1560° C. (about 2840° F.), which helps T800 retain its wear resistance to high temperature.

Because of the presence of hard and brittle laves phase, the weldability of T800 is very poor. Welding is usually carried out under a high preheat temperature, and T800 still has a cracking tendency under those conditions.

To eliminate cracking tendency, a PSP chiclet brazing material was developed. The chiclet is conventionally a square PSP plate with a thickness of about 3.8 mm (about 0.15 inches) to about 5.0 mm (about 0.20 inches). The chiclet is conventionally machined from sintered flat plates. However, machining such chiclets from a flat plate is costly and time-consuming.

### BRIEF DESCRIPTION OF THE INVENTION

In an embodiment, a process includes placing a powder composition of a first metal powder of a first alloy and a second metal powder of a second alloy in a ceramic die and sintering the powder composition in the ceramic die to form a sintered rod in the ceramic die. The process also includes removing the sintered rod from the ceramic die and slicing the sintered rod into a plurality of pre-sintered preforms.

In another embodiment, a pre-sintered preform is formed by a process including placing a powder composition of a first metal powder of a first alloy and a second metal powder of a second alloy in a ceramic die and sintering the powder composition in the ceramic die to form a sintered rod in the ceramic die. The process also includes removing the sintered rod from the ceramic die and slicing the sintered rod into a plurality of pre-sintered preforms.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 schematically shows a process of forming and brazing a pre-sintered preform.

FIG. 2 shows an end view of two sintered rods brazed at a flat position.

FIG. 3 shows the sintered rod within rectangle 3 of FIG. 2.

FIG. 4 shows an end view of two sintered rods brazed at a vertical position.

FIG. 5 shows the sintered rod within rectangle 5 of FIG. 4.

Wherever possible, the same reference numbers will be used throughout the drawings to represent the same parts.

### DETAILED DESCRIPTION OF THE INVENTION

Provided is a pre-sintered preform (PSP) and a process to produce a pre-sintered preform (PSP) as a near-net shape or net shape hardface chiclet.

Embodiments of the present disclosure, for example, in comparison to concepts failing to include one or more of the features disclosed herein, simplify manufacture of PSPs, hardface chiclets, near-net shape hardface chiclets, or net shape hardface chiclets; reduce the cost to manufacture PSPs, hardface chiclets, near-net shape hardface chiclets, or net shape hardface chiclets; or combinations thereof.

As used herein, “chiclet” refers to a piece of PSP that has a predetermined geometry and is then brazed onto a component. In some embodiments, the predetermined geometry is a substantially rectangular geometry. In some embodiments, the predetermined geometry has a length and a width that are similar in scale and a thickness that is significantly less than the length and the width.

As used herein, “rod” refers to an object having a predetermined cross section and a height that is significantly greater than the greatest length of the cross section. In some embodiments, the cross section of a rod is circular, round, square, rectangular, oval, or polygonal.

As used herein, “B93” refers to an alloy including a composition, by weight, of between about 13.7% and about 14.3% chromium (Cr), between about 9.0% and about 10.0% cobalt (Co), between 4.6% and about 5.0% titanium (Ti), between about 4.5% and about 4.8% silicon (Si), between about 3.7% and about 4.3% molybdenum (Mo), between about 3.7% and about 4.0% tungsten (W), between about 2.8% and about 3.2% aluminum (Al), between about 0.50% and about 0.80% boron (B), between about 0.13% and about 0.19% carbon (C), incidental impurities, and a balance of nickel (Ni). B93 is commercially available, for example, from Oerlikon Metco (Pfaffikon, Switzerland).

As used herein, “BNi-2” refers to an alloy including a composition, by weight, of about 7% Cr, about 4.5% Si, about 3% B, about 3% iron (Fe), incidental impurities, and a balance of Ni. BNi-2 is commercially available, for example, from Lucas-Milhaupt, Inc. (Cudahy, Wis.).

As used herein, “BNi-3” refers to an alloy including a composition, by weight, of about 4.5% Si, about 3% B, incidental impurities, and a balance of Ni. BNi-3 is commercially available, for example, from Lucas-Milhaupt, Inc.

As used herein, “BNi-5” refers to an alloy including a composition, by weight, of about 19% Cr, about 10% Si, incidental impurities, and a balance of Ni. BNi-5 is commercially available, for example, from Lucas-Milhaupt, Inc.

As used herein, “BNi-6” refers to an alloy including a composition, by weight, of about 11% phosphorus (P), incidental impurities, and a balance of Ni. BNi-6 is commercially available, for example, from Lucas-Milhaupt, Inc.

As used herein, “BNi-7” refers to an alloy including a composition, by weight, of about 14% Cr, about 10% P, incidental impurities, and a balance of Ni. BNi-7 is commercially available, for example, from Lucas-Milhaupt, Inc.

As used herein, “BNi-9” refers to an alloy including a composition, by weight, of about 15% Cr, about 3% B, incidental impurities, and a balance of Ni. BNi-9 is commercially available, for example, from Lucas-Milhaupt, Inc.

As used herein, “BNi-10” refers to an alloy including a composition, by weight, of about 16% W, about 11.5% Cr, about 3.5% Si, about 3.5% Fe, about 2.5% B, about 0.5% C, incidental impurities, and a balance of Ni. BNi-10 is commercially available, for example, from AnHui Huazhong Welding Manufacturing Co., Ltd. (Hefei, China).

As used herein, “BRB” refers to an alloy including a composition, by weight, of between about 13.0% and about 14.0% Cr, between about 9.0% and about 10.0% Co, between about 3.5% and about 3.8% Al, between about 2.25% and about 2.75% B, incidental impurities, and a balance of Ni. BRB is commercially available, for example, from Oerlikon Metco.

As used herein, “CM64” refers to an alloy including a composition, by weight, of between about 26.0% and about 30.0% Cr, between about 18.0% and about 21.0% W, between about 4.0% and about 6.0% Ni, between about 0.75% and about 1.25% vanadium (V), between about 0.7% and about 1.0% C, between about 0.005% and about 0.1% B, up to about 3.0% Fe, up to about 1.0% Mg, up to about 1.0% Si, up to about 0.5% Mo, incidental impurities, and a balance of Co. CM64 is commercially available, for example, from WESGO Ceramics, a division of Morgan Advanced Ceramics (Haywood, Calif.).

As used herein, “D15” refers to an alloy including a composition, by weight, of between about 14.8% and about 15.8% Cr, between about 9.5% and about 11.0% Co, between about 3.2% and about 3.7% Al, between about 3.0% and about 3.8% tantalum (Ta), between about 2.1% and about 2.5% B, incidental impurities, and a balance of Ni. D15 is commercially available, for example, from Oerlikon Metco.

As used herein, “DF4B” refers to an alloy including a composition, by weight, of between about 13.0% and about 15% Cr, between about 9.0% and about 11.0% Co, between about 3.25 and about 3.75% Al, between about 2.25% and about 2.75% Ta, between about 2.5% and about 3.0% B, between about 0.01% and about 0.10% yttrium (Y), incidental impurities, and a balance of Ni. DF4B is commercially available, for example, from Oerlikon Metco.

As used herein, “GTD 111” refers to an alloy including a composition, by weight, of between about 13.70% and about 14.30% Cr, between about 9.0% and about 10.0% Co, between about 4.7% and about 5.1% Ti, between about 3.5% and about 4.1% W, between about 2.8% and about 3.2% Al, between about 2.4% and about 3.1% Ta, between about 1.4% and about 1.7% Mo, about 0.35% Fe, about 0.3% Si, about 0.15% niobium (Nb), between about 0.08% and about 0.12% C, about 0.1% manganese (Mn), about 0.1% copper (Cu), about 0.04% zirconium (Zr), between about 0.005% and about 0.020% B, about 0.015% P, about 0.005% sulfur (S), incidental impurities, and a balance of Ni.

As used herein, “GTD 444” refers to an alloy including a composition, by weight, of about 9.75% Cr, about 7.5% Co, about 4.2% Al, about 3.5% Ti, about 4.8% Ta, about 6% W, about 1.5% Mo, up to about 0.5% Nb, up to about 0.2% Fe, up to about 0.2% Si, up to about 0.15% hafnium (Hf), up to about 0.08% C, up to about 0.009% Zr, up to about 0.009% B, incidental impurities, and a balance of Ni.

As used herein, “HAYNES 188” refers to an alloy including a composition, by weight, of between about 21% and about 23% Cr, between about 20% and about 24% Ni, between about 13% and about 15% W, up to about 3% Fe, up to about 1.25% Mn, between about 0.2% and about 0.5% Si, between about 0.05% and about 0.15% C, between about 0.03% and about 0.12% lanthanum (La), up to about 0.02% P, up to about 0.015% B, up to about 0.015% S, incidental impurities, and a balance of Co.

As used herein, “HAYNES 230” refers to an alloy including a composition, by weight, of about 22% Cr, about 2% Mo, about 0.5% Mn, about 0.4% Si, about 14% W, about 0.3% Al, about 0.1% C, about 0.02% La, incidental impurities, and a balance of Ni.

As used herein, “INCONEL 738” refers to an alloy including a composition, by weight, of between about 15.7% and about 16.3% Cr, about 8.0% to about 9.0% Co, between about 3.2% and about 3.7% Ti, between about 3.2% and about 3.7% Al, between about 2.4% and about 2.8% W, between about 1.5% and about 2.0% Ta, between about 1.5% and about 2.0% Mo, between about 0.6% and about 1.1% Nb, up to about 0.5% Fe, up to about 0.3% Si, up to about 0.2% Mn, between about 0.15% and about 0.20% C, between about 0.05% and about 0.15% Zr, up to about 0.015% S, between about 0.005% and about 0.015% B, incidental impurities, and a balance of Ni.

As used herein, “L605” refers to an alloy including a composition, by weight, of between about 19% and about 21% Cr, between about 14% and about 16% W, between about 9% and about 11% Ni, up to about 3% Fe, between about 1% and about 2% Mn, between about 0.05% and about 0.15% C, up to about 0.4% Si, up to about 0.04% P, up to about 0.03% S, incidental impurities, and a balance of Co.

As used herein, “MarM247” refers to an alloy including a composition, by weight, of between about 9.3% and about 9.7% W, between about 9.0% and about 9.5% Co, between about 8.0% and about 8.5% Cr, between about 5.4% and about 5.7% Al, optionally about 3.2% Ta, optionally about 1.4% Hf, up to about 0.25% Si, up to about 0.1% Mn, between about 0.06% and about 0.09% C, incidental impurities, and a balance of Ni.

As used herein, “MarM509” refers to an alloy including a composition, by weight, of between about 22.5% and about 24.25% Cr, between about 9% and about 11% Ni, between about 6.5% and about 7.5% W, between about 3% and about 4% Ta, up to about 0.3% Ti (for example, between about 0.15% and about 0.3% Ti), up to about 0.65% C (for example, between about 0.55% and about 0.65% C), up to about 0.55% Zr (for example, between about 0.45% and about 0.55% Zr), incidental impurities, and a balance of Co.

As used herein, “MarM509B” refers to an alloy including a composition, by weight, of between about 22.00% and about 24.75% Cr, between about 9.0% and about 11.0% Ni, between about 6.5% and about 7.6% W, between about 3.0% and about 4.0% Ta, between about 2.6% and about 3.16% B, between about 0.55% and about 0.64% C, between about 0.30% and about 0.60% Zr, between about 0.15% and about 0.30% Ti, up to about 1.30% Fe, up to about 0.40% Si, up to about 0.10% Mn, up to about 0.02% S, incidental impurities, and a balance of Co. MarM509B is commercially available, for example, from WESGO Ceramics.

As used herein, “Rene 108” refers to an alloy including a composition, by weight, of between about 9% and about 10% Co, between about 9.3% and about 9.7% W, between about 8.0% and about 8.7% Cr, between about 5.25% and about 5.75% Al, between about 2.8% and about 3.3% Ta, between about 1.3% and about 1.7% Hf, up to about 0.9% Ti (for example, between about 0.6% and about 0.9% Ti), up to about 0.6% Mo (for example, between about 0.4% and about 0.6% Mo), up to about 0.2% Fe, up to about 0.12% Si, up to about 0.1% Mn, up to about 0.1% Cu, up to about 0.1% C (for example, between about 0.07% and about 0.1% C), up to about 0.1% Nb, up to about 0.02% Zr (for example, between about 0.005% and about 0.02% Zr), up to about 0.02% B (for example, between about 0.01% and about 0.02% B), up to about 0.01% P, up to about 0.004% S, incidental impurities, and a balance of Ni.

As used herein, “Rene 142” refers to an alloy including a composition, by weight, of about 12% Co, about 6.8% Cr, about 6.4% Ta, about 6.1% Al, about 4.9% W, about 2.8% rhenium (Re), about 1.5% Mo, about 1.5% Hf, about 0.12% C, about 0.02% Zr, about 0.015% B, incidental impurities, and a balance of Ni.

As used herein, “Rene 195” refers to an alloy including a composition, by weight, of about 7.6% Cr, about 3.1% Co, about 7.8% Al, about 5.5% Ta, about 0.1% Mo, about 3.9% W, about 1.7% Re, about 0.15% Hf, incidental impurities, and a balance of Ni.

As used herein, “Rene N2” refers to an alloy including a composition, by weight, of about 13% Cr, about 7.5% Co, about 6.6% Al, about 5% Ta, about 3.8% W, about 1.6% Re, about 0.15% Hf, incidental impurities, and a balance of Ni.

As used herein, “STELLITE 6” refers to an alloy including a composition, by weight, of between about 27.0% and about 32.0% Cr, between about 4.0% and about 6.0% W, between about 0.9% and about 1.4% C, up to about 3.0% Ni, up to about 3.0% Fe, up to about 2.0% Si, up to about 1.0% Mo, incidental impurities, and a balance of Co. STELLITE 6 is commercially produced, for example, by Deloro Stellite Inc. (Belleville, Ontario, Canada).

As used herein, “T800” refers to an alloy including a composition, by weight, of between about 27.0% and about 30.0% Mo, between about 16.5% and about 18.5% Cr, between about 3.0% and 3.8% Si, up to about 1.5% Fe, up to about 1.5% Ni, up to about 0.15% oxygen (O), up to about 0.08% C, up to about 0.03% P, up to about 0.03% S, incidental impurities, and a balance of Co. T800 is produced, for example, by Deloro Stellite Inc. and is commercially available, for example, from WESGO Ceramics.

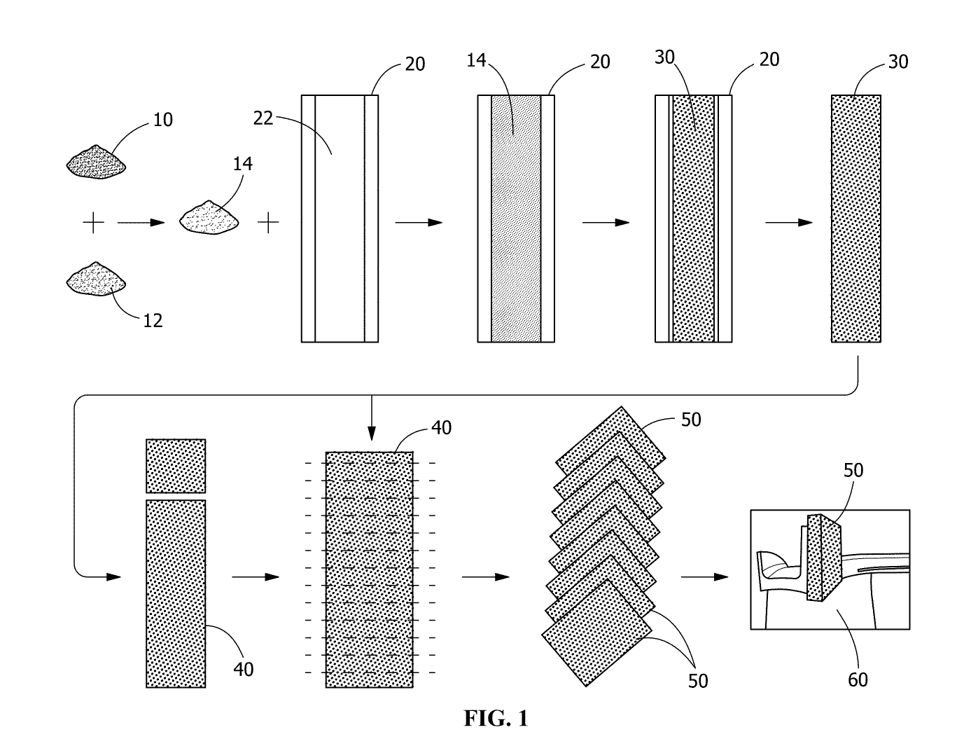

Referring to FIG. 1, a process may include combining and mixing a first melt powder 10 of a first alloy and a second melt powder 12 of a second alloy to form a powder composition 14. The first alloy and the second alloy have different melting temperatures such that heating the powder composition 14 to a sinter temperature sinters the powder composition into a sintered rod 30 without melting the first metal powder 10. The process includes filling a cavity 22 of a ceramic die 20 with the powder composition 14. In some embodiments, the ceramic die 20 is a ceramic tube, a ceramic container, or a ceramic boat. The ceramic die 20 may be made of any ceramic material capable of withstanding the conditions of the sintering, which may include, but are not limited to, aluminum oxide (Al₂O₃), zirconium oxide (ZrO₂), silicon carbide (SiC), silicon nitride (Si₃N₄), or aluminum nitride (AlN).

The process further includes heating the ceramic die 20 with the cavity 22 filled with the powder composition 14 to a sintering temperature to form a sintered rod 30 in the cavity 22 from the powder composition 14. In some embodiments, the sintering occurs in a vacuum furnace. In some embodiments, the temperature for the sintering is in the range of about 1150° C. (about 2100° F.) to about 1290° C. (about 2350° F.).

The process optionally includes machining the sintered rod 30 to alter the cross sectional geometry of the sintered rod 30 and form a machined sintered rod 40 having a predetermined cross sectional geometry.

The process then includes machining the sintered rod 30 or the machined sintered rod 40 into small slices to form a plurality of PSPs 50. In some embodiments, the machining may include, but is not limited to, turning, boring, milling, grinding, electro-discharge machining (EDM), laser cutting, water jetting, or a combination thereof. The slice locations and thickness are preferably selected to form PSPs 50 from the sintered rod 30 or machined sintered rod 40 having predetermined thicknesses. In some embodiments, the PSP 50 is a net shape or near-net shape hardface chiclet. The predetermined thicknesses may be the same for some, all, or none of the PSPs 50 from a single sintered rod 30 or machined sintered rod 40.

The process may further include brazing a PSP 50 to a surface of an article 60. In some embodiments, the temperature for the brazing is in the range of about 1150° C. (about 2100° F.) to about 1290° C. (about 2350° F.).

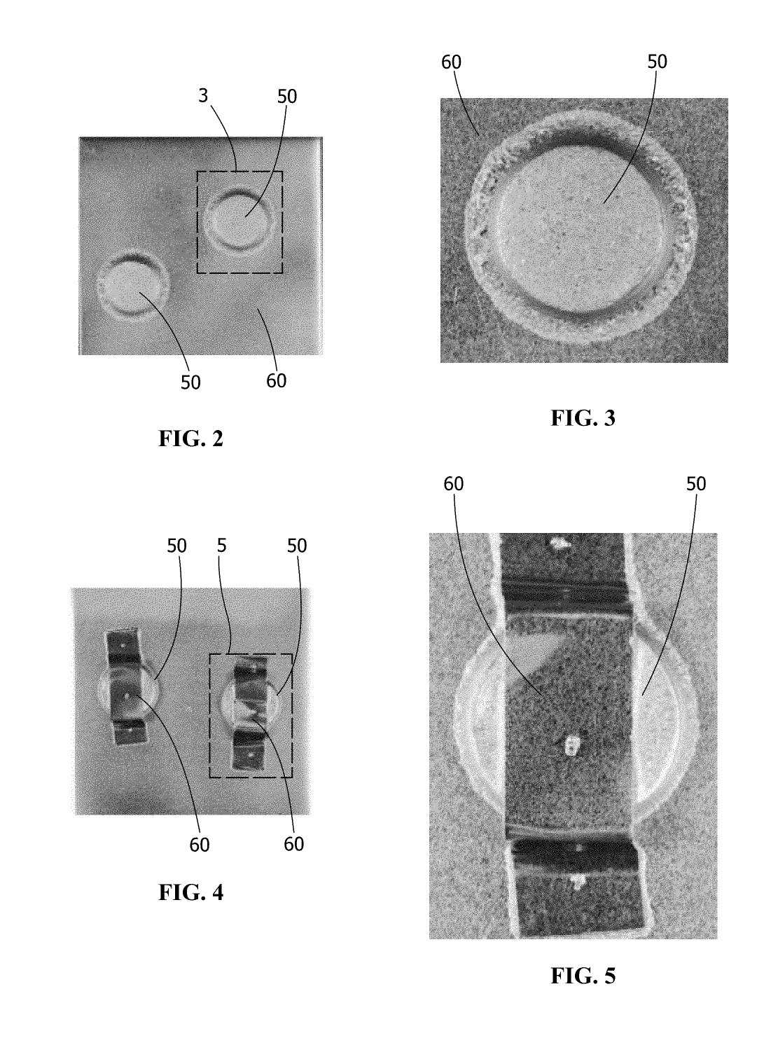

Referring to FIG. 2, a pair of PSPs 50 were brazed to an article 60 at a flat position of a flat end surface of the PSPs 50 to form an excellent braze joint. FIG. 3 shows one of the PSPs 50 on the article 60 from the image of FIG. 2 in more detail within the rectangle 3.

Referring to FIG. 4, a pair of PSPs 50 were brazed to two similar articles 60 at a vertical position of a curved side surface of the PSPs 50 to form an excellent braze joint. FIG. 5 shows one of the PSPs 50 on one of the articles 60 from the image of FIG. 4 in more detail within the rectangle 5.

In some embodiments, the powder composition 14 includes a first alloy and a second alloy intermixed with one another as distinct phases. The first alloy has a higher melting temperature than the second alloy. The first alloy is a high melt alloy powder and may include a first melting point of at least about 1320° C. (about 2400° F.), and the second alloy is a low melt alloy powder and may include a second melting point of below about 1290° C. (about 2350° F.). In some embodiments, the first alloy is a hardfacing material.

The first alloy may include one or more hard-to-weld (HTW) alloys, refractory alloys, superalloys, nickel-based superalloys, cobalt-based superalloys, iron-based superalloys, titanium-aluminum superalloys, iron-based alloys, steel alloys, stainless steel alloys, cobalt-based alloys, nickel-based alloys, titanium-based alloys, hard surfacing alloys, T800, CM64, GTD 111, GTD 444, HAYNES 188, HAYNES 230, INCONEL 738, L605, MarM247, MarM509, Rene 108, Rene 142, Rene 195, Rene N2, STELLITE 6, or combinations thereof.

The second alloy may include one or more braze alloys, iron-based alloys, steel alloys, stainless steel alloys, cobalt-based alloys, nickel-based alloys, titanium-based alloys, B93, BNi-2, BNi-3, BNi-5, BNi-6, BNi-7, BNi-9, BNi-10, BRB, DF4B, D15, MarM509B, or combinations thereof.

In some embodiments, the powder composition 14 further includes one or more ceramic additives, such as, but not limited to, aluminum oxide, silicon carbide, tungsten carbide, titanium nitride, titanium carbonitride, titanium carbide, or combinations thereof.

In some embodiments, the powder composition 14 includes a mixture of about 90% by weight of the first alloy and about 10% by weight of the second alloy, alternatively about 80% by weight of the first alloy and about 20% by weight of the second alloy, alternatively about 70% by weight of the first alloy and about 30% by weight of the second alloy, alternatively about 60% by weight of the first alloy and about 40% by weight of the second alloy, alternatively about 50% by weight of the first alloy and about 50% by weight of the second alloy, alternatively about 45% by weight of the first alloy and about 55% by weight of the second alloy, or any value, range, or sub-range therebetween. In some embodiments, the first alloy is T800. In some embodiments, the second alloy is MarM509B.

A ceramic die 20 with a cavity 22 contoured to produce a sintered rod 30 having a predetermined cross sectional geometry is filled with a mixture of a first melt powder 10 and a second melt powder 12 in a predetermined ratio. In some embodiments, the ceramic die 20 is a ceramic tube. The cross section of the tube may be any geometry, including, but not limited to, round, square, rectangular, or oval. In some embodiments, the cavity 22 is cylindrical with an inner diameter of about 1.3 cm (about 0.50 inches). In some embodiments, no binder material is used. The cross section of the sintered rod 30 may be any geometry, including, but not limited to, circular, round, square, rectangular, oval, or polygonal depending on the geometry of the cross section of the ceramic die 20.

The powder composition 14 is sintered by heating in the cavity 22 to form a sintered rod 30. The sintered rod 30 may have a cross section that is already net shape or near-net shape. Alternatively, a cross section having a net shape or a near-net shape may be achieved by grinding or otherwise machining the sintered rod 30 to form a machined sintered rod 40.

The net shape or near-net shape sintered rod 30 or machined sintered rod 40 is sliced in sections having the net shape or near-net shape cross section and a predetermined thickness. In some embodiments, the predetermined thickness is that of a PSP hardface chiclet.

The PSP hardface chiclet is brazed to the surface of an article 60. In some embodiments, the PSP hardface chiclet is tack welded to the surface of the article 60 at a predetermined location prior to performing the brazing process to form the hardfaced surface.

In some embodiments, the sintered rod 30 has a height in the range of about 46 cm (about 18 in.) to about 91 cm (about 36 in.), alternatively about 61 cm (about 24 in.) to about 76 cm (about 30 in.), alternatively about 46 cm (about 18 in.) to about 61 cm (about 24 in.), alternatively about 46 cm (about 18 in.), alternatively about 61 cm (about 24 in.), alternatively about 76 cm (about 30 in.), alternatively about 91 cm (about 36 in.), or any value, range, or sub-range therebetween. In some embodiments, the sintered rod 30 has a maximum cross sectional length in the range of about 6.4 mm (about 0.25 in.) to about 2.5 cm (about 1 in.), alternatively about 1.0 cm (about 0.4 in.) to about 1.9 cm (about 0.75 in), alternatively about 1.3 cm (about 0.5 in.), or any value, range, or sub-range therebetween. In some embodiments, the thickness of the PSP 50 is in the range of about 2.5 mm (about 0.1 in.) to about 6.4 mm (about 0.25 in.), alternatively about 3.8 mm (about 0.15 in.) to about 5.1 mm (about 0.2 in.), alternatively about 3.8 mm (about 0.15 in.), alternatively about 5.1 mm (about 0.2 in.), or any value, range, or sub-range therebetween.

In some embodiments, the article 60 is an original equipment manufacturer (OEM) part or the surface of the article 60 may be any surface that would benefit from a hardface or any hole that would benefit from a seal.

In some embodiments, the sintered rod 30 or the machined sintered rod 40 is used as a core and a mixture of a high melt powder, a low melt powder, and a binder serves as a coating, with the combination being extruded and sintered to provide a hybrid PSP material combination for certain applications. The coating may include the same first melt powder 10 and/or second melt powder 12 as the core, or alternative alloy materials may be used instead. The geometry of the cross sectional area of the coating may be any geometry, including, but not limited to, round, square, rectangular, or oval.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A process comprising:
placing a powder composition of a first metal powder of a first alloy and a second metal powder of a second alloy in a ceramic die;
sintering the powder composition in the ceramic die to form a sintered rod in the ceramic die;
removing the sintered rod from the ceramic die; and
slicing the sintered rod into a plurality of pre-sintered preforms (PSPs).

2. The process of claim 1, wherein the first alloy has a first melting point of about 2400° F. or greater and the second alloy has a second melting point of about 2350° F. or less.

3. The process of claim 1 further comprising mixing the first metal powder with the second metal powder to form the powder composition.

4. The process of claim 1, wherein the sintering occurs in a vacuum furnace.

5. The process of claim 1, wherein the ceramic die has a cross section selected from the group consisting of circular, oval, rectangular, and polygonal.

6. The process of claim 1, wherein the sintered rod has a height in the range of about 46 cm to about 91 cm.

7. The process of claim 1 further comprising machining the sintered rod to a predetermined cross sectional geometry prior to slicing the sintered rod.

8. The process of claim 7, wherein the sintered rod has a cross section selected from the group consisting of circular, oval, square, and rectangular after the machining of the sintered rod.

9. The process of claim 7, wherein the plurality of PSPs have the predetermined cross sectional geometry.

10. The process of claim 1, wherein the slicing comprises a machining process selected from the group consisting of turning, boring, milling, grinding, electro-discharge machining, laser cutting, water jetting, and a combination thereof.

11. The process of claim 1 further comprising brazing one of the plurality of PSPs to an article.

12. The process of claim 11 further comprising tack welding the one of the plurality of PSPs to the article prior to brazing the one of the plurality of PSPs to the article.

13. The process of claim 1, wherein the PSP has a thickness of about 3 mm to about 10 mm.

14. The process of claim 1, wherein the first alloy has a composition, by weight, of between about 27.0% and about 30.0% molybdenum, between about 16.5% and about 18.5% chromium, between about 3.0% and 3.8% silicon, up to about 1.5% iron, up to about 1.5% nickel, up to about 0.15% oxygen, up to about 0.08% carbon, up to about 0.03% phosphorus, up to about 0.03% sulfur, incidental impurities, and a balance of cobalt.

15. The process of claim 1, wherein the second alloy has a composition, by weight, of between about 22.00% and about 24.75% chromium, between about 9.0% and about 11.0% nickel, between about 6.5% and about 7.6% tungsten, between about 3.0% and about 4.0% tantalum, between about 2.6% and about 3.16% boron, between about 0.55% and about 0.64% carbon, between about 0.30% and about 0.60% zirconium, between about 0.15% and about 0.30% titanium, up to about 1.30% iron, up to about 0.40% silicon, up to about 0.10% manganese, up to about 0.02% sulfur, incidental impurities, and a balance of cobalt.

16. The process of claim 1, wherein the first metal powder and the second metal powder are present in the powder composition in a ratio, by weight, in the range of 90:10 to 45:55.

17. The process of claim 1, wherein the powder composition includes no binder material.

18. The process of claim 1, wherein the PSP is a chiclet.

19. A pre-sintered preform formed by the process of claim 1.
